(19) United States
(12) Patent Application Publication
(10) Pub. No.: US 2020/0363924 A1
(43) Pub. Date: Nov. 19, 2020

(54) AUGMENTED REALITY DRAG AND DROP OF OBJECTS

(71) Applicant: KONINKLIJKE PHILIPS N.V., EINDHOVEN (NL)

(72) Inventors: MOLLY LARA FLEXMAN, MELROSE, MA (US); JARL JOHN PAUL BLIJD, NEWTON, MA (US); ATUL GUPTA, BALA CYNWYD, PA (US); ASHISH PANSE, BURLINGTON, MA (US)

(21) Appl. No.: 16/762,162

(22) PCT Filed: Nov. 6, 2018
(86) PCT No.: PCT/EP2018/080238

§ 371 Date: May 7, 2020

Related U.S. Application Data
(60) Provisional application No. 62/582,484, filed on Nov. 7, 2017.

(51) Int. Cl. G06F 3/0486; G06F 3/01; G06F 3/0481; G06F 3/0484; G06T 19/00

(52) U.S. Cl. CPC G06F 3/0486; G06F 3/011; G06T 19/006; G06F 3/04842; G06F 3/04815

(57) ABSTRACT

An augmented reality drag and drop device (40) comprising an augmented reality display (41) and an augmented reality drag and drop controller. In operation, the augmented reality display (41) displays a virtual object (e.g., virtual content or a virtual item) relative to a view of a physical object within a physical world (e.g., physical content or a physical item), and the augmented reality drag and drop controller (43) controls a drag and drop operation involving the virtual object and the physical object. The drag and drop operation may involve a dragging of the virtual object onto the physical object and/or a dragging of the physical object onto the virtual object.

### FIELD OF THE INVENTION

The present disclosure generally relates to an utilization of augmented reality, particularly in a medical setting. The present disclosure specifically relates to a dragging of content from a virtual world to a dropping of the content into a physical world, and a dragging of content from the physical world to a dropping of the content into the virtual world.

### BACKGROUND OF THE INVENTION

There is an ever increasing degree of information available to and required by medical personnel during a medical procedure. This information completes for limited space on physical screens available in the procedure room. Wearable glasses that provided augmented reality views of the procedure room may create opportunities for more flexible screens that may be placed anywhere in the procedure room and dynamically configured by a user of the glasses.

Despite the promise of virtual screens, there are still key reasons to have physical screens and interfaces thereof in the procedure room.

First, an image quality of a physical screen may be better than an image quality of a virtual screen.

Second, for safety reasons, it may be necessary to always have certain images presented on a physical screen (e.g., live X-ray image).

Third, a physical screen may be a key source of information and interaction among the medical personnel if not everyone in the procedure room is wearing augmented reality glasses.

As a result, there exists a need to create a seamless flow of information between physical screens, virtual screens and other objects in the procedure room, particularly a flow that does not complicate and burden a workflow of the medical procedure.

### SUMMARY OF THE INVENTION

Augmented reality (AR) generally refers to a device displaying a live image stream that is supplemented with additional computer-generated information. More particularly, the live image stream may be via the eye, cameras, smart phones, tablets, etc., and is augmented via a display to the AR user via glasses, contact lenses, projections or on the live image stream device itself (e.g., smart phone, tablet, etc.). The inventions of the present disclosure are premised on a dragging of content from a virtual world to a dropping of the content into a physical world and a dragging of content from the physical world to a dropping of the content into the virtual world to thereby minimize any interruption to the workflow of procedure, particularly a medical procedure.

One embodiment of the inventions of the present disclosure is an augmented reality drag and drop device comprising an augmented reality display and an augmented reality drag and drop controller. In operation, the augmented reality display displays a virtual object relative to a view of a physical object within a physical world, and the augmented reality drag and drop controller configured to control a drag and drop operation involving the virtual object and the physical object.

A second embodiment of the inventions of the present disclosure is the augmented reality drag and drop controller comprising an object delineation module to delineate the physical object in the display of the virtual object relative to the view of the physical object within the physical world. The augmented reality drag and drop controller comprises an object manager configured to control a drag and drop operation involving the virtual object and the physical object.

A third embodiment of the inventions of the present disclosure is an augmented reality drag and drop method comprising a display of a virtual object relative to a view of a physical object within a physical world, and a control of a drag and drop operation involving the virtual object and the physical object.

For purposes of describing and claiming the inventions of the present disclosure:

(1) terms of the art including, but not limited to, “virtual object”, “virtual screen”, “virtual content”, “virtual item”, “physical object”, “physical screen”, “physical content”, “physical item” and “drag and drop” are to be interpreted as known in the art of the present disclosure and as exemplary described in the present disclosure;

(2) the term “augmented reality device” broadly encompasses all devices, as known in the art of the present disclosure and hereinafter conceived, implementing an augmented reality overlaying virtual object(s) on a view of a physical world based on a camera image of the physical world. Examples of an augmented reality device include, but are not limited to, augmented reality head-mounted displays (e.g., GOOGLE GLASS™, HOLOLENS™, MAGIC LEAP™, VUSIX™ and META™);

(3) the term “augmented reality drag and drop device” broadly encompasses any and all augmented reality devices implementing the inventive principles of the present disclosure directed to a drag and drop operation involving a virtual object and a physical object as exemplary described in the present disclosure;

(4) the term “physical device” broadly encompasses all devices other than an augmented reality device as known in the art of the present disclosure and hereinafter conceived. Examples of a physical device pertinent to medical procedures include, but are not limited to, medical imaging modalities (e.g., X-ray, ultrasound, computed-tomography, magnetic resonance imaging, etc.), medical robots, medical diagnostic/monitoring devices (e.g., an electrocardiogram monitor) and medical workstations. Examples of a medical workstation include, but are not limited to, an assembly of one or more computing devices, a display/monitor, and one or more input devices (e.g., a keyboard, joysticks and mouse) in the form of a standalone computing system, a client computer of a server system, a desktop, a laptop or a tablet;

(5) the term “physical drag and drop device” broadly encompasses all any and all physical devices implementing the inventive principles of the present disclosure directed to a drag and drop operation involving a virtual object and a physical object as exemplary described in the present disclosure;

(6) the term “controller” broadly encompasses all structural configurations, as understood in the art of the present disclosure and as exemplary described in the present disclosure, of an application specific main board or an application specific integrated circuit for controlling an application of various inventive principles of the present disclosure as exemplary described in the present disclosure. The structural configuration of the controller may include, but is not limited to, processor(s), computer-usable/computer readable storage medium(s), an operating system, application module(s), peripheral device controller(s), slot(s) and port(s). A controller may be housed within or communicatively linked to an augmented reality drag and drop device or a physical drag and drop device;

(7) the descriptive labels for controllers described and claimed herein facilitate a distinction between controllers as described and claimed herein without specifying or implying any additional limitation to the term “controller”;

(8) the term “application module” broadly encompasses an application incorporated within or accessible by a controller consisting of an electronic circuit (e.g., electronic components and/or hardware) and/or an executable program (e.g., executable software stored on non-transitory computer readable medium(s) and/or firmware) for executing a specific application;

(9) the descriptive labels for application modules described and claimed herein facilitate a distinction between application modules as described and claimed herein without specifying or implying any additional limitation to the term “controller”;

(10) the terms “signal”, “data” and “command” broadly encompasses all forms of a detectable physical quantity or impulse (e.g., voltage, current, or magnetic field strength) as understood in the art of the present disclosure and as exemplary described in the present disclosure for transmitting information and/or instructions in support of applying various inventive principles of the present disclosure as subsequently described in the present disclosure. Signal/data/command communication various components of the present disclosure may involve any communication method as known in the art of the present disclosure including, but not limited to, signal/data/command transmission/reception over any type of wired or wireless datalink and a reading of signal/data/commands uploaded to a computer-usable/computer readable storage medium; and

(11) the descriptive labels for signals/data/commands as described and claimed herein facilitate a distinction between signals/data/commands as described and claimed herein without specifying or implying any additional limitation to the terms “signal”, “data” and “command”.

The foregoing embodiments and other embodiments of the inventions of the present disclosure as well as various structures and advantages of the inventions of the present disclosure will become further apparent from the following detailed description of various embodiments of the inventions of the present disclosure read in conjunction with the accompanying drawings. The detailed description and drawings are merely illustrative of the inventions of the present disclosure rather than limiting, the scope of the inventions of the present disclosure being defined by the appended claims and equivalents thereof.

### BRIEF DESCRIPTION OF THE DRAWINGS

FIG. 1 illustrates an exemplary embodiment of augmented reality drag and drop methods in accordance with the inventive principles of the present disclosure.

FIGS. 2A-2F illustrate exemplary embodiments of a dragging of a virtual object from a virtual world to a dropping of the virtual object onto a physical screen of a physical world in accordance with the augmented reality drag and drop methods of FIG. 1.

FIGS. 3A-3F illustrate exemplary embodiments of a dragging of a virtual object from a virtual world to a dropping of the virtual object onto a physical item of a physical world in accordance with the augmented reality drag and drop methods of FIG. 1.

FIGS. 4A-4F illustrate exemplary embodiments of a dragging of a physical object from a physical world to a dropping of the physical object onto a virtual screen of a virtual world in accordance with the augmented reality drag and drop methods of FIG. 1.

FIGS. 5A-5F illustrate exemplary embodiments of a dragging of a physical object from a physical world to a dropping of the physical object onto a virtual item of a virtual world in accordance with the augmented reality drag and drop methods of FIG. 1.

FIGS. 6A-6C illustrate exemplary embodiments of a hybrid drag and drop operation in accordance with the augmented reality drag and drop methods of FIG. 1.

FIG. 7 illustrates an additional exemplary embodiment of a hybrid drag and drop operation in accordance with the augmented reality drag and drop methods of FIG. 1.

FIG. 8 illustrate exemplary embodiments of an augmented reality drag and drop device and a physical drag and drop device in accordance with the inventive principles of the present disclosure.

FIG. 9 illustrates an exemplary implementation of augmented reality drag and drop device of the present disclosure in the context of an X-ray imaging of a patient anatomy.

### DETAILED DESCRIPTION OF THE PREFERRED EMBODIMENTS

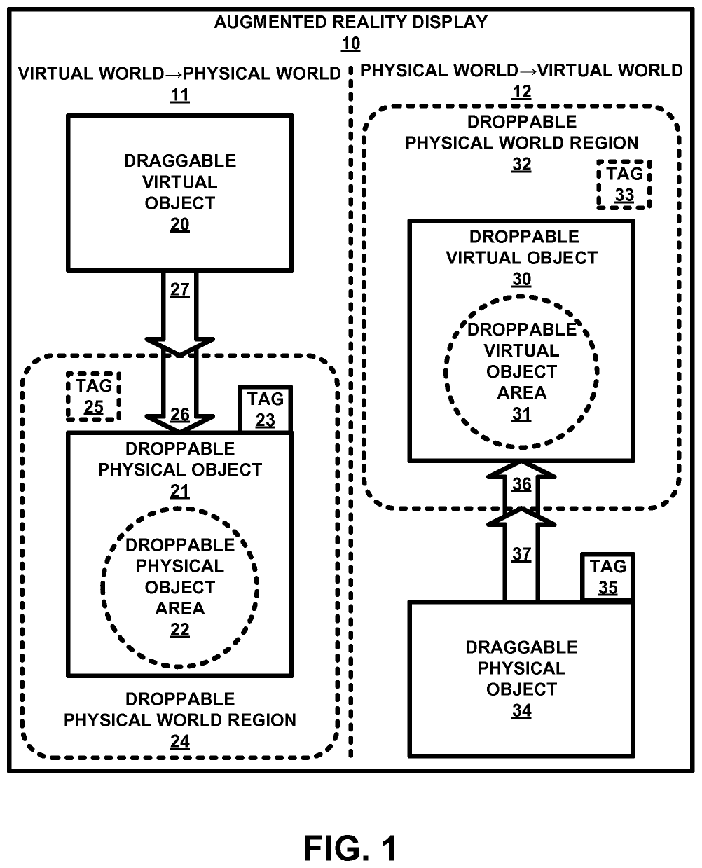

To facilitate an understanding of the various inventions of the present disclosure, the following description of FIG. 1 teaches basic inventive principles of augmented reality drag and drop methods of the present disclosure. From this description, those having ordinary skill in the art will appreciate how to apply the inventive principles of the present disclosure for making and using additional embodiments of augmented reality drag and drop methods of the present disclosure.

Generally, the augmented reality drag and drop methods of the present disclosure generally involve a live view of physical objects in a physical world via eye(s), a camera, a smart phone, a tablet, etc. that is augmented with information embodied as displayed virtual objects in the form of virtual content/links to content (e.g., images, text, graphics, video, thumbnails, protocols/recipes, programs/scripts, etc.) and/or virtual items (e.g., a 2D screen, a hologram, and a virtual representation of a physical object in the virtual world).

More particularly, a live video feed of the physical world facilitates a mapping of a virtual world to the physical world whereby computer generated virtual objects of the virtual world are positionally overlaid on the live view of the physical objects in the physical world. The augmented reality drag and drop methods of the present disclosure utilize advanced technology like computer vision, spatial mapping, and object recognition as well as customized technology like manual delineation to facilitate drag and drop operations of objects between the physical world and the virtual world via interactive tools/mechanisms (e.g., gesture recognition (including totems), voice commands, head tracking, eye tracking and totems (like a mouse)).

More particularly, referring to FIG. 1, the augmented reality drag and drop methods of the present disclosure provide for a drag and drop operation 11 whereby a virtual object of a virtual world displayed on virtual screen by an augmented reality display 10 is pushed to a physical world, and a drag and drop operation 12 wherein a physical object is pulled from a physical world to the virtual world displayed on the virtual screen by augmented reality display 10.

In practice, for the augmented reality drag and drop methods of the present disclosure, a virtual object is any computer-generated display of information via augmented reality display 10 in the form of virtual content/links to content (e.g., images, text, graphics, video, thumbnails, protocols/recipes, programs/scripts, etc.) and/or virtual items (e.g., a hologram and a virtual representation of a physical object in the virtual world). For example, in a context of a medical procedure, virtual objects may include, but not be limited to:
(1) displayed text of a configuration of a medical imaging apparatus;
(2) displayed graphics of a planned path through a patient anatomy;
(3) a displayed video of a previous recording of a live view of the medical procedure;
(4) a displayed thumbnail linked to a text, graphics or a video;
(5) a hologram of a portion or an entirety of a patient anatomy;
(6) a virtual representation of a surgical robot;
(7) a live image feed from a medical imager (ultrasound, interventional x-ray, etc.);
(8) live data traces from monitoring equipment (e.g., an ECG monitor);
(9) live images of any screen display;
(10) a displayed video (or auditory) connection to a third party (e.g., another augmented reality device wearer in a different room, medical personal via webcam in their office and equipment remote support);
(11) a recalled position of an object visualized as either text, an icon, or a hologram of the object in that stored position; and
(12) a visual inventory of medical devices available or suggested for a given procedure.

Additionally, a draggable virtual object 20 and a droppable virtual object 30 are virtual objects actionable via a user interface of augmented reality display 10 for an execution of drag and drop operations 11 and 12 as will be further described in the present disclosure.

Further in practice, for the augmented reality drag and drop methods of the present disclosure, a physical object is any view of information via a physical display, bulletin boards, etc. (not shown) in the form of content/links to content (e.g., text, graphics, video, thumbnails, etc.) and/or any physical item. For example, in a context of a medical procedure, virtual objects may include, but not be limited to:
(1) a physical screen with displayed images of a patient anatomy;
(2) a table-side monitor with displayed graphics of a tracked path of a tool/instrument through the patient anatomy;
(3) a displayed video of a previous execution of the medical procedure;
(4) a displayed thumbnail linked to text, graphics or a video; and
(5) any medical devices and/or apparatuses for performing the medical procedure (e.g., an x-ray system, an ultrasound system, a patient monitoring system, a table-side control panel, a sound system, a lighting system, a robot, a monitor, a touch screen, a tablet, a phone, medical equipment/tools/instruments, additional augmented reality devices and workstations running medical software like image processing, reconstruction, image fusion, etc.).

Additionally, a draggable physical object 21 and a droppable physical object 34 are physical objects actionable via a user interface for an execution of drag and drop operations 11 and 12 as will be further described in the present disclosure.

Still referring to FIG. 1, drag and drop operation 11 may encompasses a dragging/dropping 26 of draggable virtual object 20 as displayed on a virtual screen via augmented reality display 10 onto a live view of droppable physical object 21, or onto a designated area 22 of droppable physical object 21 (e.g., via computer vision of droppable physical object 21), or onto an object delineation of a physical/displayed tag 23 associated with droppable physical object 21.

Alternatively or concurrently, drag and drop operation 11 may encompass a dragging/dropping 27 of draggable virtual object 20 as displayed on the virtual screen via augmented reality display 10 onto a live view of a designated region 24 of the physical world (e.g., computer vision of designated region 24), or onto an object recognition of a physical/displayed tag 25 associated with designated region 24.

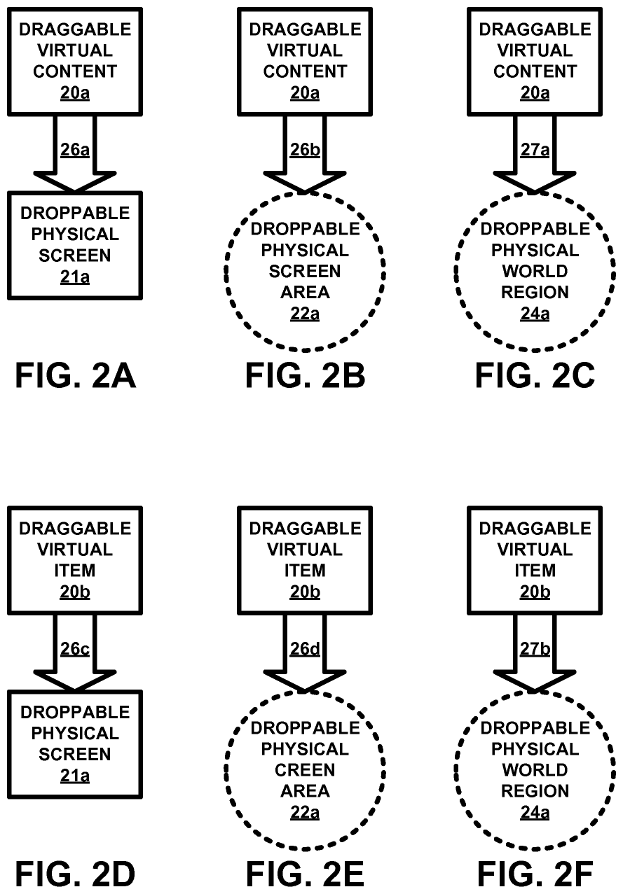

By example of drag and drop operation 11, FIG. 2A illustrates a dragging/dropping 26a of a draggable virtual content 20a onto a tagged/untagged droppable physical screen 21a.

By further example of drag and drop operation 11, FIG. 2B illustrates a dragging/dropping 26b of draggable virtual content 20a onto a designated area 22 of a tagged/untagged droppable physical screen 21a.

By further example of drag and drop operation 11, FIG. 2C illustrates a dragging/dropping 27a of draggable virtual content 20a onto a tagged/untagged designated region 24a of the physical world encircling tagged/untagged droppable physical screen 21a.

For these three (3) examples of drag and drop operation 11 in a context of a medical procedure (e.g., an imaging, diagnosis and/or treatment of a patient anatomy), draggable virtual content 20a may be virtual screen of a planned path through a patient anatomy that is drag and dropped for display onto a physical screen of a medical imaging modality (e.g., a X-ray imaging modality or an ultrasound imaging modality), or onto a designated area of the physical screen of the X-ray imaging modality (e.g., an upper left hand corner of the physical screen), or onto a designated region of the physical world (e.g., a region of a procedure room encircling the X-ray imaging modality).

By further example of drag and drop operation 11, FIG. 2D illustrates a dragging/dropping 26c of a draggable virtual item 20b onto a tagged/untagged droppable physical screen 21a.

By further example of drag and drop operation 11, FIG. 2E illustrates a dragging/dropping 26d of draggable virtual item 20b onto a designated area 22 of a tagged/untagged droppable physical screen 21a.

By further example of drag and drop operation 11, FIG. 2F illustrates a dragging/dropping 27b of draggable virtual item 20b onto a tagged/untagged designated region 24b of the physical world encircling tagged/untagged droppable physical screen 21a.

For these three (3) examples drag and drop operation 11 in a context of a medical procedure (e.g., an imaging, diagnosis and/or treatment of a patient anatomy), draggable virtual item 20b may a hologram of a patient anatomy that is drag and dropped for display onto a physical screen of a medical imaging modality (e.g., a X-ray imaging modality or an ultrasound imaging modality), or onto a designated area of the physical screen (e.g., an upper left hand corner of the physical screen), or onto a designated region of the physical world (e.g., a region of a procedure room encircling the X-ray imaging modality).

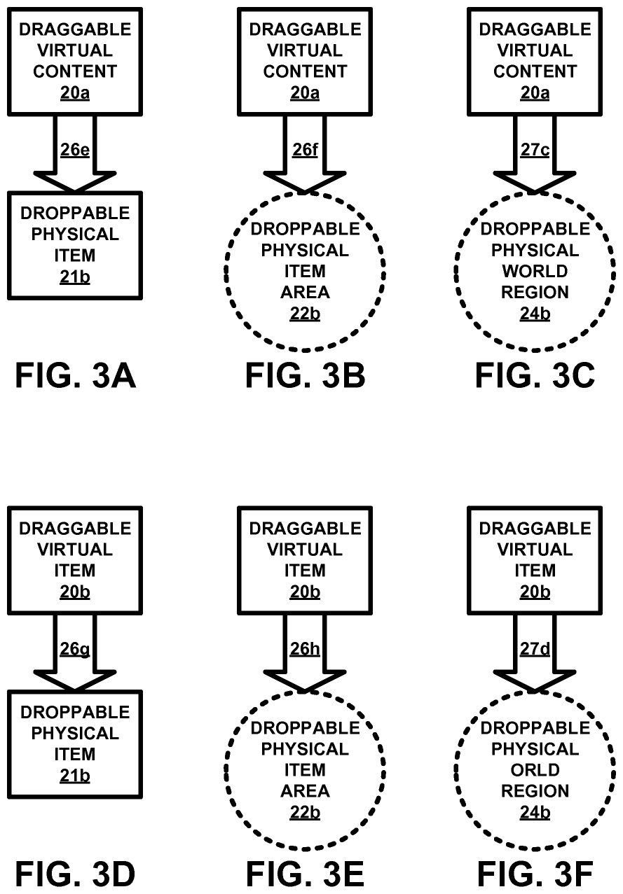

By further example of drag and drop operation 11, FIG. 3A illustrates a dragging/dropping 26e of a draggable virtual content 20a onto a tagged/untagged droppable physical item 21b.

By further example of drag and drop operation 11, FIG. 3B illustrates a dragging/dropping 26f of draggable virtual content 20a onto a designated area 22b of a tagged/untagged droppable physical item 21b.

By further example of drag and drop operation 11 FIG. 3C illustrates a dragging/dropping 27c of draggable virtual content 20a onto a tagged/untagged designated region 24c of the physical encircling world tagged/untagged droppable physical item 21b.

For these three (3) examples of drag and drop operation 11 in a context of a medical procedure (e.g., an imaging, diagnosis and/or treatment of a patient anatomy), draggable virtual content 20a may be a device configuration delineated on a virtual procedure card displayed on augmented reality display 10 that is drag and dropped onto a medical imaging modality (e.g., a X-ray imaging modality or an ultrasound imaging modality), or onto a designated area of the physical screen of the X-ray imaging modality (e.g., an upper left hand corner of the physical screen), or onto designated region of the physical world (e.g., a region of a procedure room encircling the X-ray imaging modality) for a configuring of the medical imaging equipment (acquisition settings, positioning information, etc.).

Additionally, draggable virtual content 20a may be a virtual screen of content or a composite of virtual screens of content that is drag and dropped onto additional tagged/untagged augmented reality devices (i.e., additional physical objects in the live view of augmented reality display 10) whereby the content may or may not be shared by the users of the augmented reality devices. A sharing of content may be accomplished by a virtual coupling of all of the displays of the augmented reality devices as known in the art of the present disclosure, or by a common screen layout for each augmented reality device with an intermittent continual drag and drop of the virtual screen(s).

By further example of drag and drop operation 11, FIG. 3D illustrates a dragging/dropping 26g of a draggable virtual item 20b onto a tagged/untagged droppable physical item 21b.

By further example of drag and drop operation 11, FIG. 3E illustrates a dragging/dropping 26g of draggable virtual item 20b onto a designated area 22b of a tagged/untagged droppable physical item 21b.

By further example of drag and drop operation 11, FIG. 3F illustrates a dragging/dropping 27b of draggable virtual item 20d onto a tagged/untagged designated region 24c of the physical world encircling tagged/untagged droppable physical item 21b.

For these three (3) examples of drag and drop operation 11 in a context of a medical procedure (e.g., an imaging, diagnosis and/or treatment of a patient anatomy), draggable virtual item 20b may a virtual representation of a medical tool (e.g., a guidewire) that is drag and dropped onto a medical imaging modality (e.g., a X-ray imaging modality or an ultrasound imaging modality), onto a designated area of medical imaging modality (e.g., an upper left hand corner of the physical screen) or onto a designated region of the medical imaging modality (e.g., a region of a procedure room encircling the X-ray imaging modality) to inform the medical imaging modality of an upcoming imaging of a guidewire.

Referring back to FIG. 1, drag and drop operation 12 may encompass a dragging/dropping 36 of draggable physical object 34 as viewed live on augmented reality display 10 onto a display of droppable virtual object 30, or onto a designated area 31 of droppable virtual object 30 (e.g., via a computer vision of droppable virtual object 30).

Alternatively or concurrently, a dragging/dropping 37 of draggable physical object 34 as viewed live on augmented reality display 10 onto a display designated region 32 of the physical world, or onto an object delineation of a phyiscal/displayed tag 33.

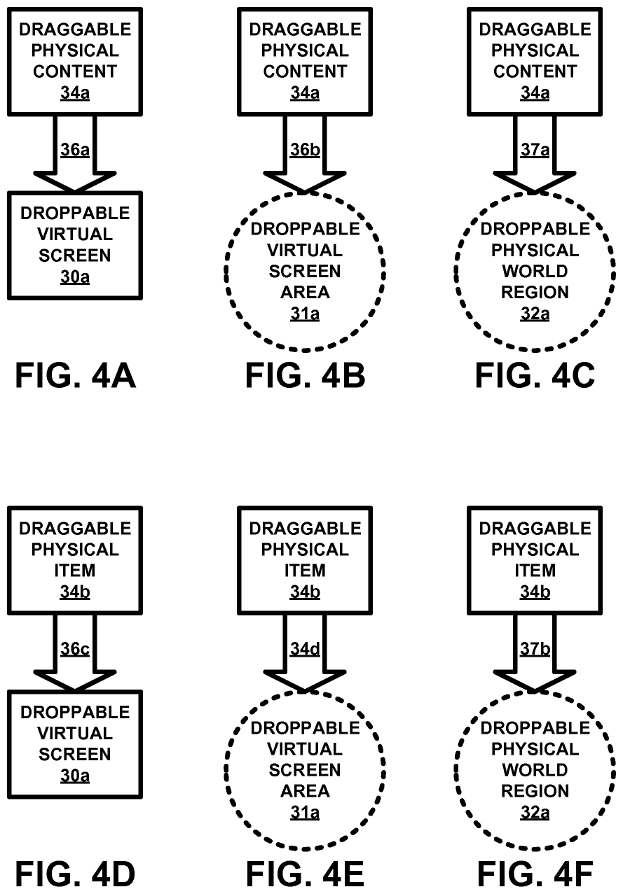

By example of drag and drop operation 12, FIG. 4A illustrates a dragging/dropping 36a of a draggable physical content 34a onto a droppable virtual screen 30a.

By further example of drag and drop operation 12, FIG. 4B illustrates a dragging/dropping 36b of draggable physical content 34a onto a designated area 31a of a droppable virtual screen 30a.

By further example of drag and drop operation 12, FIG. 4C illustrates a dragging/dropping 37a of draggable physical content 34a onto a tagged/untagged designated region 32a of the physical world (e.g., a drop box).

For these three (3) examples of drag and drop operation 12 in a context of a medical procedure (e.g., an imaging, diagnosis and/or treatment of a patient anatomy), draggable physical content 34a may be an image of a patient anatomy displayed on a physical screen that is drag and dropped for display onto a virtual screen of augmented reality display 10, or onto a designated area of the virtual screen of augmented reality display 10, or onto a tagged/untagged designated region 32a of the physical world.

By further example of drag and drop operation 12, FIG. 4D illustrates a dragging/dropping 36c of a draggable physical item 34b onto droppable virtual screen 30a.

By further example of drag and drop operation 12, FIG. 4E illustrates a dragging/dropping 36d of draggable physical item 34b onto a designated area of droppable virtual screen 30a.

By further example of drag and drop operation 12, FIG. 4F illustrates a dragging/dropping 37b of draggable physical item 34b onto a tagged/untagged designated region 32b of the physical world (e.g., a drop box).

For these three (3) examples of drag and drop operation 12 in a context of a medical procedure (e.g., an imaging, diagnosis and/or treatment of a patient anatomy), draggable physical item 34b may an anatomical model that is drag and dropped onto a virtual screen of augmented reality display 10, or onto a designated area of the virtual screen of augmented reality display 10, or onto a tagged/untagged designated region 32a of the physical world for a generation of a hologram of the anatomical model.

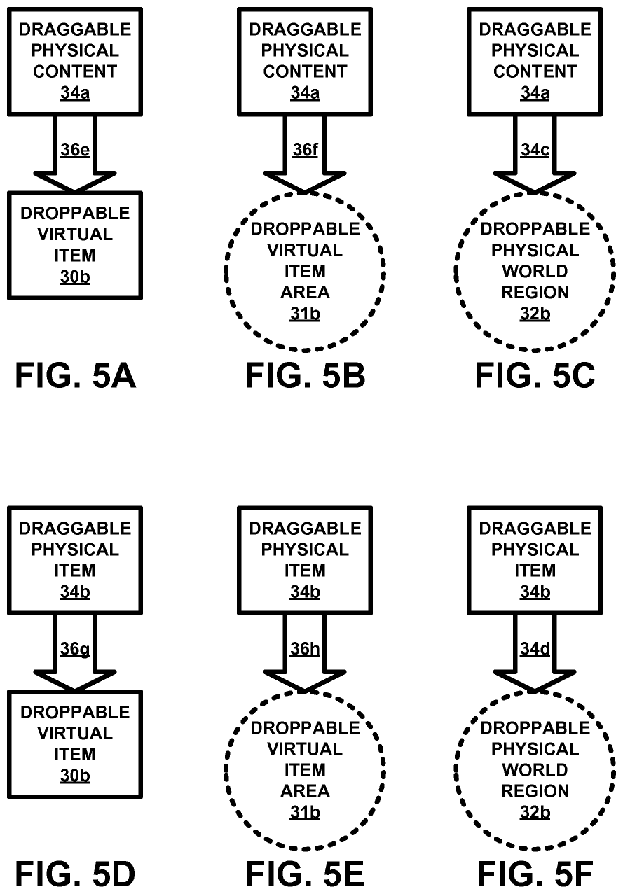

By further example of drag and drop operation 12, FIG. 5A illustrates a dragging/dropping 36e of a draggable physical content 34a onto a droppable virtual item 30b.

By further example of drag and drop operation 12, FIG. 5B illustrates a dragging/dropping 36f of draggable physical content 34a onto a designated area 31b of droppable virtual item 30b.

By further example of drag and drop operation 12, FIG. 5C illustrates a dragging/dropping 37c of draggable physical content 34a onto a tagged/untagged designated region 32b of the physical world (e.g., a drop box).

For these three (3) examples of drag and drop operation 12 in a context of a medical procedure (e.g., an imaging, diagnosis and/or treatment of a patient anatomy), draggable physical content 34a an image of a patient anatomy that is drag and dropped onto a hologram of an anatomical model, or onto a designated area of the hologram of the anatomical model, or onto a tagged/untagged designated region 32a of the physical world for an overlay of the image of the patient anatomy on the hologram of the anatomical model.

By further example of drag and drop operation 12, FIG. 5D illustrates a dragging/dropping 36g of a draggable physical item 34b onto a droppable virtual item 30b.

By further example of drag and drop operation 12, FIG. 5E illustrates a dragging/dropping 36h of draggable physical item 34b onto a designated area 31b of a droppable virtual item 30b.

By further example of drag and drop operation 12, FIG. 5F illustrates a dragging/dropping 37d of draggable physical content 34b onto a tagged/untagged designated region 32b of the physical world (e.g., a drop box).

For these three (3) examples of drag and drop operation 12 in a context of a medical procedure (e.g., an imaging, diagnosis and/or treatment of a patient anatomy), draggable physical item 34b may medical tool (e.g., a needle) that is drag and dropped a hologram of an anatomical model, onto a designated area of the hologram of the anatomical model, or onto a tagged/untagged designated region 32a of the physical world for a generation of a virtual representation of the needle.

Referring back to FIG. 1, additional embodiments of the augmented reality drag and drop methods of the present disclosure involve a combination/merger of drag and drop operations 11 and 12.

By example of a combination/merger of drag and drop operations 11 and 12 in the context of a medical procedure (e.g., an imaging, diagnosis and/or treatment of a patient anatomy), augmented reality drag and drop methods of the present disclosure may involve an augmented reality device being operated to establish a wireless connection between a pre-operative imaging workstation and an intraoperative imaging workstation. If during the medical procedure, a physician wants to compare intra-operative images with pre-operative images, then the physician may drag and drop the intra-operative images from the intra-operative imaging workstation as viewed live on the augmented reality display 10 on to a virtual screen area or physical world region designated for image fusion, followed by a drag and drop of virtual intra-operative images to the pre-operative imaging workstation for image fusion. The augmented reality device thus serves as a mediator between pre-operative imaging workstation and an intraoperative imaging workstation, The result of the image fusion may be dragged and dropped to augmented reality device, and displayed on a virtual screen or a physical screen as determined by the user.

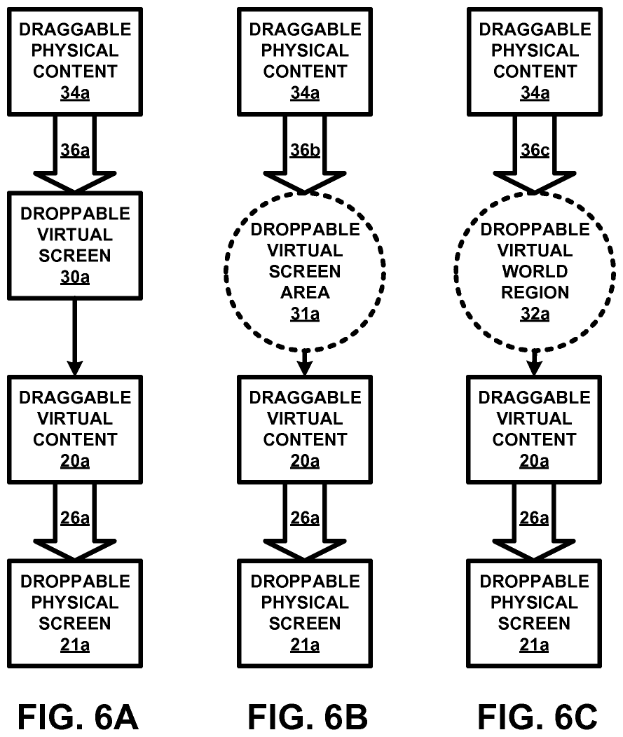

For this example, FIGS. 6A-6C illustrate a draggable physical content 33a as displayed on a pre-operative imaging workstation that may be dragged and dropped onto a droppable virtual screen 30a (FIG. 6A), or onto a designated area 31a of virtual screen 30a (FIG. 6B), or onto a designated region 32a of the physical world (FIG. 6C). Draggable physical content 33a is convertible to draggable virtual content 20a displayed on augmented reality display whereby draggable virtual content 20a may be dragged and dropped onto a droppable physical screen 21a of an intra-operative imaging workstation (FIGS. 6A-6C).

By further example of a combination/merger of drag and drop operations 11 and 12 in the context of a medical procedure (e.g., an imaging, diagnosis and/or treatment of a patient anatomy), augmented reality drag and drop methods of the present disclosure may involve an augmented reality device being operated to move a physical object within the physical world. More particularly, a draggable physical object as viewed on the augmented reality display 10 may be grabbed at a current position in a live view of the physical object within the physical world whereby a draggable virtual representation or hologram may be generated and dropped onto a new position within the physical world. The new position may be communicated to another medical personal to move the physical object from the current position to the new position or a mechanical apparatus (e.g., a robot) may be commanded to move to move the physical object from the current position to the new position.

By further example of a combination/merger of drag and drop operations 11 and 12 in the context of a medical procedure (e.g., an imaging, diagnosis and/or treatment of a patient anatomy), augmented reality drag and drop methods of the present disclosure may involve an augmented reality device being operated to control an operation of one physical object based on another physical object. More particularly, a physical object (e.g., an ultrasound transducer) as viewed on the augmented reality display 10 may be grabbed at a current position in a live view of the physical object within the physical world whereby a draggable virtual representation may be generated and dropped onto a droppable physical object (e.g., a FlexVision™ monitor). This would facilitate an accurate interaction between the two physical object(s) (e.g., an accurate display by the monitor of ultrasound images generated by that particular ultrasound transducer).

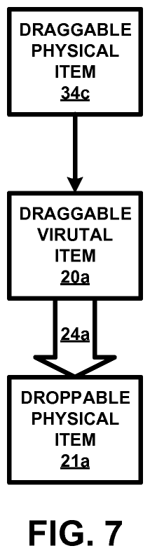

For those two (2) examples of a combination/merger of drag and drop operations 11 and 12, FIG. 7 illustrates a draggable physical content 33a as viewed live via augmented reality display 10 within the physical world that is convertible to draggable virtual content 20a displayed on the virtual screen of augmented reality display 10 whereby draggable virtual content 20a may be dragged and dropped onto a droppable physical screen 21a.

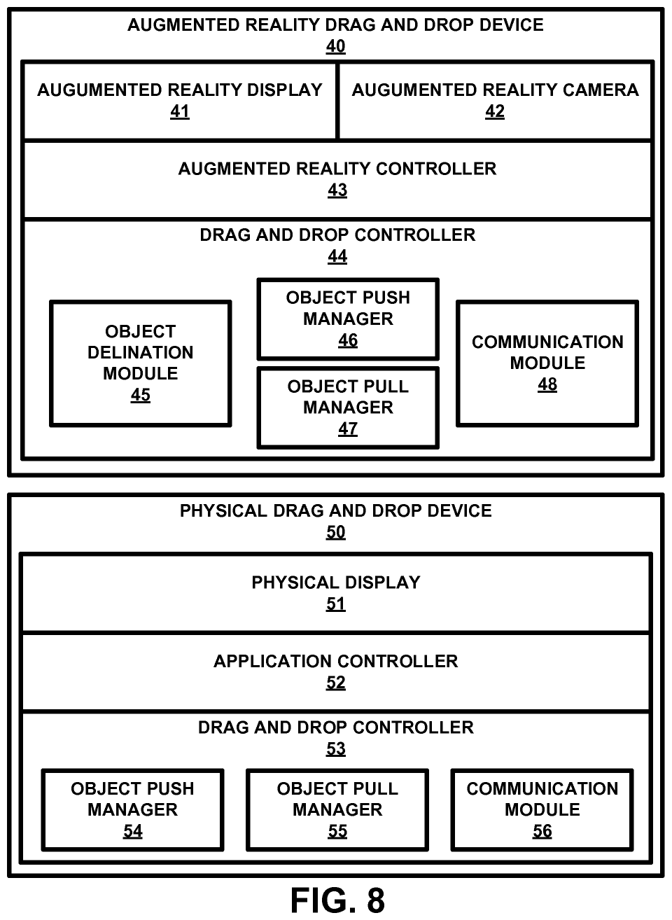

To facilitate a further understanding of the various inventions of the present disclosure, the following description of FIG. 8 teaches basic inventive principles of augmented reality drag and drop devices of the present disclosure and physical reality drag and drop devices of the present disclosure. From this description, those having ordinary skill in the art will appreciate how to apply the inventive principles of the present disclosure for making and using additional embodiments of augmented reality drag and drop devices of the present disclosure and physical reality drag and drop devices of the present disclosure.

Referring to FIG. 8, an augmented reality drag and drop device 40 of the present disclosure employs an augmented reality display 41, an augmented reality camera 42, an augmented reality controller 43 and interactive tools/mechanisms (not shown) (e.g., gesture recognition (including totems), voice commands, head tracking, eye tracking and totems (like a mouse)) as known in the art of the present disclosure for generating and displaying virtual object(s) relative to a live view of a physical world including physical objects to thereby augment the live view of the physical world.

Augmented reality drag and drop device 40 further employs a drag and drop controller 44 of the present disclosure for implementing one or more augmented reality drag and drop methods of the present disclosure as previously described in the present disclosure via the interactive tools/mechanisms.

In practice, controllers 43 and 44 may be segregated as shown, or partially or wholly integrated.

Still referring to FIG. 8, a physical drag and drop device 50 employs a physical display 51 and an application controller 52 for implementing one or more applications as known in the art of the present disclosure.

Physical drag and drop device 50 further employs a drag and drop controller 53 of the present disclosure for implementing one or more augmented reality drag and drop methods of the present disclosure as previously described in the present disclosure.

In practice, controllers 52 and 53 may be segregated as shown, or partially or wholly integrated. Also in practice, controller 53 may be remote connected to device 50.

Still referring to FIG. 8, each controller includes processor(s), memory, a user interface, a network interface, and a storage interconnected via one or more system buses.

Each processor may be any hardware device, as known in the art of the present disclosure or hereinafter conceived, capable of executing instructions stored in memory or storage or otherwise processing data. In a non-limiting example, the processor may include a microprocessor, field programmable gate array (FPGA), application-specific integrated circuit (ASIC), or other similar devices.

The memory may include various memories, as known in the art of the present disclosure or hereinafter conceived, including, but not limited to, L1, L2, or L3 cache or system memory. In a non-limiting example, the memory may include static random access memory (SRAM), dynamic RAM (DRAM), flash memory, read only memory (ROM), or other similar memory devices.

The user interface may include one or more devices, as known in the art of the present disclosure or hereinafter conceived, for enabling communication with a user such as an administrator. In a non-limiting example, the user interface may include a command line interface or graphical user interface that may be presented to a remote terminal via the network interface.

The network interface may include one or more devices, as known in the art of the present disclosure or hereinafter conceived, for enabling communication with other hardware devices. In an non-limiting example, the network interface may include a network interface card (NIC) configured to communicate according to the Ethernet protocol. Additionally, the network interface may implement a TCP/IP stack for communication according to the TCP/IP protocols. Various alternative or additional hardware or configurations for the network interface will be apparent.

The storage may include one or more machine-readable storage media, as known in the art of the present disclosure or hereinafter conceived, including, but not limited to, read-only memory (ROM), random-access memory (RAM), magnetic disk storage media, optical storage media, flash-memory devices, or similar storage media. In various non-limiting embodiments, the storage may store instructions for execution by the processor or data upon with the processor may operate. For example, the storage may store a base operating system for controlling various basic operations of the hardware. The storage also stores application modules in the form of executable software/firmware for implementing the various functions of the controllers as further described in the present disclosure.

Still referring to FIG. 8, drag and drop controller 43 employs a computer delineation module 45 for delineating a physical object in a virtual screen displayed by an augmented reality device display 41.

In practice, computer delineation module 45 may implement any technique known in the art of the present disclosure for delineating a physical object in a virtual screen displayed by an augmented reality device display 41. Non-limiting examples of such techniques include computer vision, spatial mapping and object recognition techniques as known in the art of the present disclosure, and a manual delineation of the present disclosure as will be further described in the present disclosure.

Drag and drop controller 43 further employs one or more object managers including an object push manager 46 for controlling a drag and drop operation of the present disclosure involving a push of a virtual object onto a physical object as previously exemplary described in the present disclosure (e.g., drag and drop operation 11 of FIG. 1), and an object pull manager 47 for controlling a drag and drop operation involving a pull of a physical object onto a virtual object as previously exemplary described in the present disclosure (e.g., drag and drop operation 12 of FIG. 1).

Similarly, drag and drop controller 53 employs one or more object manager including an object push manager 54 for controlling a drag and drop operation of the present disclosure involving a push of a virtual object onto a physical object as previously exemplary described in the present disclosure (e.g., drag and drop operation 11 of FIG. 1), and an object pull manager 55 for controlling a drag and drop operation involving a pull of a physical object onto a virtual object as previously exemplary described in the present disclosure (e.g., drag and drop operation 12 of FIG. 1).

Drag and drop controller 44 further employs a communication module 48 and drag and drop controller 53 further employs a communication module 56 for cooperatively establishing and supporting communications between object push manager 46 and object push manager 54 involving a push of a virtual object onto a physical object as previously exemplary described in the present disclosure (e.g., drag and drop operation 11 of FIG. 1), and for cooperatively establishing and supporting communications between object pull manager 47 and object pull manager 55 involving a pull of a physical object onto a virtual object as previously exemplary described in the present disclosure (e.g., drag and drop operation 12 of FIG. 1).

In practice, communication modules 48 and 56 may implement any communication technique known in the art of the present disclosure for establishing and supporting such communications. Non-limiting examples of such communication techniques include internet protocol suite/real-time multimedia transport protocols (e.g., User Datagram Protocol (UDP).

Still referring to FIG. 8, a push of a virtual object onto a physical object by object push manager 46 and object push manager 54 involves object push manager 46 providing a user interface to facilitate a dragging aspect of the virtual object via a virtual screen of augmented reality display 41 and the interactive tools/mechanisms. To this end, object push manager 46 includes hardware/circuitry and/or executable software/firmware implementing dragging techniques customized for augmented reality display 41.

A push of a virtual object onto a physical object by object push manager 46 and object push manager 54 further involves object push manager 46 communicating the virtual object to object push manager 54 whereby such communication includes metadata of the virtual object for facilitating a dropping of the virtual object onto the physical object by object push manager 54, which includes hardware/circuitry and/or executable software/firmware implementing dropping techniques customized for physical display 54 and/or application controller 53.

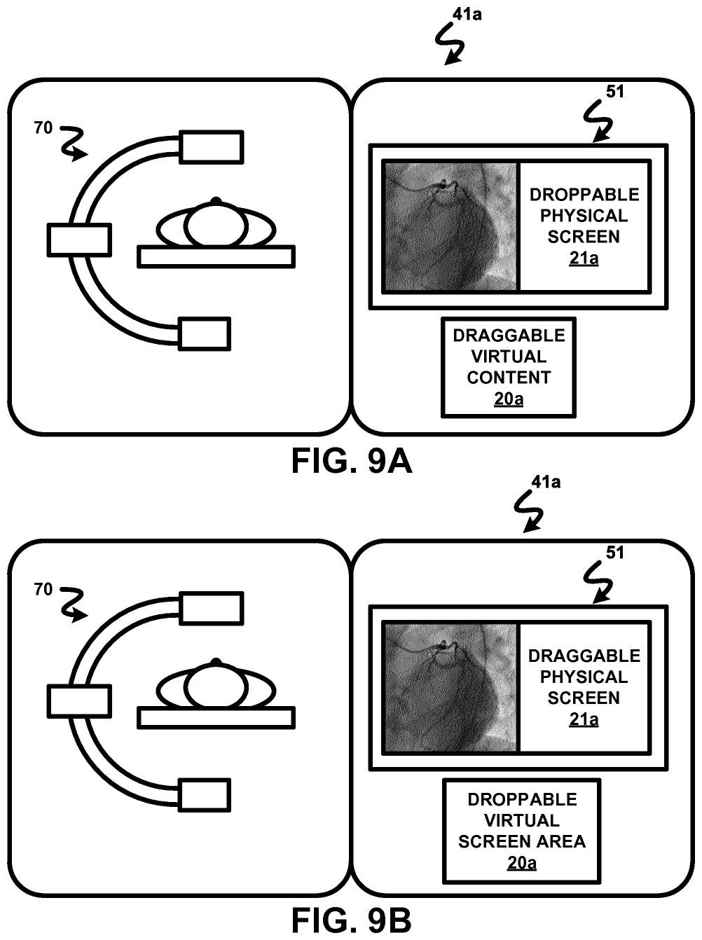

For example, an augmented reality drag and drop method may involve object push manager 46 establishing communication with object push manager 54 via communication modules 49 and 56 whereby, as shown in FIG. 9A, object push manager 46 may command object push manager 54 to display draggable virtual content 20a on a droppable physical screen 21a of a physical display 51 based on a live view 41a of an X-ray medical procedure 70 and physical display 51 via augmented reality display 41.

Referring back to FIG. 8, similarly, a pull of a physical object onto a virtual object by object pull manager 47 and object pull manager 55 involves object pull manager 47 providing a user interface to facilitate a dragging aspect of the physical object via a virtual screen of augmented reality display 41 and the interactive tools/mechanisms. To this end, object pull manager 47 includes hardware/circuitry and/or executable software/firmware implementing dragging techniques customized for augmented reality display 41.

A pull of a physical object onto a virtual object by object pull manager 47 and object pull manager 55 further involves object pull manager 47 communicating a request for the physical object to object pull manager 55 whereby object pull manager 55 responds with the physical content and associated metadata for facilitating a dropping of the physical object onto the virtual object by object pull manager 47, which further includes hardware/circuitry and/or executable software/firmware implementing dropping techniques customized for augmented reality display 41.

For example, an augmented reality drag and drop method may involve object pull manager 47 establishing communication with an object pull manager 55 of physical drag and drop device 50 via communication modules 49 and 56 whereby, as shown in FIG. 9B, object pull manager 47 and object pull manager 55 execute a handshaking protocol to display draggable physical screen 21a on a droppable virtual screen area 20a of augmented reality display 41 again based on a live view 41a of an X-ray medical procedure 70 and physical display 51 via augmented reality display 41.

Referring back to FIG. 8, in practice, managers 47, 48, 54 and 55 may incorporate a user interface in many forms.

For example, in its most natural form, the user interface will be based on a gesture where the user pinches or grabs a virtual object with their hand and then drags it overtop of the physical object where they would like it to go. In one embodiment, objects can only be ‘unlocked’ for drag and drop with some kind of initialization command. More particularly, objects cannot necessarily be dragged and dropped onto any object in the room, so once the drag-and-drop is initialized, the objects that are visible to the user that are ‘eligible’ for drag-and-drop can be flagged to the user in their display (through a highlighting, and aura, or a target appearing near the target object where the user should ‘drop’ the virtual object). Instead of using a hand gesture for drag-and-drop, as previously stated, an augmented reality drag and drop method may be implemented via other user interaction tools such as voice, head tracking, eye tracking, a totem, or a stylus. Dragging objects from the physical world into the virtual world can be accomplished by a tap or other similar gesture on the appropriate region matching the draggable object.

Still referring to FIG. 8, more particularly to a setup phase of manual delineation, object delineation module 45 has a “dev mode” whereby a user of AR drag and drop device 40 sees a two-dimensional or a three-dimensional representation(s) of a “draggable region” and/or a “droppable region” via AR display 41. The dev mode of object delineation module 45 enables the use to position the draggable region representation (e.g., a cube) and/or the droppable region representation (e.g., a cube) at any location and/or orientation with the physical world. In practice, a positioning of the regions may be specific to any physical object in the physical world, may be arbitrary as related to the physical objects in the physical world, and may or may not overlap to any degree.

For example, the draggable representation may be aligned with one physical drag and drop device 50 in the physical world (e.g., a table side monitor) and the droppable region may be aligned with a different physical drag and drop device 50 in the physical world (e.g., a display of a medical imaging modality). By further example, the draggable representation may be aligned with a heavily used region of the physical world and the droppable region may be aligned with sparsely used region of the physical world.

An application phase of the manual delineation may involve a dragging of a virtual object of AR display 41 (e.g., virtual content or a virtual screen of content) overlapping the delineated droppable region whereby object push manager 46 is triggered to send a command via communication module 48 over WiFi (via UDP protocol) to object push manager 54. The command includes a flag to indicate which virtual object was dropped onto the delineated droppable region. Object push manager 54 then takes an action to change to operate device 50 in accordance with the virtual object (e.g., manager 54 may change what is being displayed on physical display 50, or may change a pose of a robot being controlled by device 50). As previously stated, drag and drop controller 53 may be remote from physical drag and drop device 50 (e.g., controller 53 running on a separate workstation running in the room) or may be housed within physical drag and drop device 50) (e.g., device 50 being a tablet with controller 53 housed therein).

Still referring to FIG. 8, an application phase of the manual delineation may involve object pull manager 47 enabling a tap of the draggable region to display a physical object within the droppable region into the virtual world. More particularly, upon a tap of the draggable region, object pull manager 47 sends a query via communication module 48 to object pull manager 55 to find out what content is being displayed on physical display 51 (e.g., content or a hologram) and object pull manager 55 sends back the information via communication module 56. From the communication, object pull manager 47 knows which screen or hologram to display on AR display 41.

Alternatively, object pull manager 47 may be configured to actually recognize physical object(s) being displayed by physical display 51 via object recognition techniques of the present disclosure whereby object pull manager 47 automatically decides which physical object(s) to display on AR display 41.

Referring to FIGS. 1-9, those having ordinary skill in the art of the present disclosure will appreciate numerous benefits of the inventions of the present disclosure including, but not limited to, a seamless flow of information between virtual objects in a virtual world and physical objects in a physical world.

For example, increased information during a medical procedure requires a need to perform additional data processing that is accomplished mainly during a planning phase of the medical procedure between a pre-operative phase and an intra-operative phase. Often the planning phase requires medical personnel to scrub out at the end of the pre-operative phase to leave the procedure room to execute the planning phase and to scrub back in to perform the intra-operative phase. The inventions of the present disclosure provide augmented reality drag and drop methods, controllers and devices to simply the workflow between phases of the medical procedure and to introduce new processing methods to facilitate completion of the medical procedure without complicating the workflow between the phases of the medical procedure.

Further, as one having ordinary skill in the art will appreciate in view of the teachings provided herein, structures, elements, components, etc. described in the present disclosure/specification and/or depicted in the Figures may be implemented in various combinations of hardware and software, and provide functions which may be combined in a single element or multiple elements. For example, the functions of the various structures, elements, components, etc. shown/illustrated/depicted in the Figures can be provided through the use of dedicated hardware as well as hardware capable of executing software in association with appropriate software for added functionality. When provided by a processor, the functions can be provided by a single dedicated processor, by a single shared processor, or by a plurality of individual processors, some of which can be shared and/or multiplexed. Moreover, explicit use of the term “processor” or “controller” should not be construed to refer exclusively to hardware capable of executing software, and can implicitly include, without limitation, digital signal processor (“DSP”) hardware, memory (e.g., read only memory (“ROM”) for storing software, random access memory (“RAM”), non-volatile storage, etc.) and virtually any means and/or machine (including hardware, software, firmware, combinations thereof, etc.) which is capable of (and/or configurable) to perform and/or control a process.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (e.g., any elements developed that can perform the same or substantially similar function, regardless of structure). Thus, for example, it will be appreciated by one having ordinary skill in the art in view of the teachings provided herein that any block diagrams presented herein can represent conceptual views of illustrative system components and/or circuitry embodying the principles of the invention. Similarly, one having ordinary skill in the art should appreciate in view of the teachings provided herein that any flow charts, flow diagrams and the like can represent various processes which can be substantially represented in computer readable storage media and so executed by a computer, processor or other device with processing capabilities, whether or not such computer or processor is explicitly shown.

Having described preferred and exemplary embodiments of the various and numerous inventions of the present disclosure (which embodiments are intended to be illustrative and not limiting), it is noted that modifications and variations can be made by persons skilled in the art in light of the teachings provided herein, including the Figures. It is therefore to be understood that changes can be made in/to the preferred and exemplary embodiments of the present disclosure which are within the scope of the embodiments disclosed herein.

Moreover, it is contemplated that corresponding and/or related systems incorporating and/or implementing the device/system or such as may be used/implemented in/with a device in accordance with the present disclosure are also contemplated and considered to be within the scope of the present disclosure. Further, corresponding and/or related method for manufacturing and/or using a device and/or system in accordance with the present disclosure are also contemplated and considered to be within the scope of the present disclosure.

1. An augmented reality drag and drop device, comprising:
an augmented reality display operable to display a virtual object relative to a view of a physical object within a physical world; and
an augmented reality drag and drop controller configured to control, in cooperation with a physical drag and drop controller of a physical drag and drop device, a drag and drop operation involving the virtual object and the physical object.

2. The augmented reality drag and drop device of claim 1, wherein the augmented reality drag and drop controller is further configured to control, in cooperation with the physical drag and drop controller of the physical drag and drop device, a drag and drop of the virtual object as displayed by the augmented reality display onto the view of the physical object.

3. The augmented reality drag and drop device of claim 1, wherein the augmented reality drag and drop controller is further configured to control, in cooperation with the physical drag and drop controller of the physical drag and drop device, a drag and drop of the virtual object as displayed by augmented reality display onto the view of a designated area of the physical object.

4. The augmented reality drag and drop device of claim 1, wherein the augmented reality drag and drop controller is further configured to control, in cooperation with the physical drag and drop controller of the physical drag and drop device, a drag and drop of the virtual object as displayed by augmented reality display onto a view of a designated region of the physical world.

5. The augmented reality drag and drop device of claim 1, wherein the augmented reality drag and drop controller is further configured to control, in cooperation with the physical drag and drop controller of the physical drag and drop device,a drag and drop of the physical object onto the virtual object as displayed by the augmented reality display.

6. The augmented reality drag and drop device of claim 1, wherein the augmented reality drag and drop controller is further configured to control, in cooperation with the physical drag and drop controller of the physical drag and drop device, a drag and drop of the physical object onto a designated area of the virtual object as displayed by the augmented reality display.

7. The augmented reality drag and drop device of claim 1, wherein the augmented reality drag and drop controller is further configured to control, in cooperation with the physical drag and drop controller of the physical drag and drop device, a drag and drop of the physical object onto a designated region of the physical world.

8. An augmented reality drag and drop controller, comprising:
an object delineation module configured to delineate a physical object in a display by an augmented reality device display of a virtual object relative to a view of the physical object within a physical world; and
an object manager configured to control, in cooperation with the physical drag and drop controller of the physical drag and drop device, a drag and drop operation involving the virtual object and the physical object as delineated by the object delineation module.

9. The augmented reality drag and drop controller of claim 8, wherein the object manager is further configured to control, in cooperation with the physical drag and drop controller of the physical drag and drop device, a drag and drop of the virtual object onto the view of the physical object.

10. The augmented reality drag and drop controller of claim 8, wherein the object manager is further configured to control, in cooperation with the physical drag and drop controller of the physical drag and drop device, a drag and drop of the virtual object onto the view of a designated area of the physical object.

11. The augmented reality drag and drop controller of claim 8, wherein the object manager is further configured to control, in cooperation with the physical drag and drop controller of the physical drag and drop device,a drag and drop of the virtual object onto a view of a designated region of the physical world.

12. The augmented reality drag and drop controller of claim 8, wherein the object manager is further configured to control, in cooperation with the physical drag and drop controller of the physical drag and drop device, a drag and drop of the physical object onto the virtual object as displayed by the augmented reality display.

13. The augmented reality drag and drop controller of claim 8, wherein the object manager is further configured to control, in cooperation with the physical drag and drop controller of the physical drag and drop device, the drag and drop of the physical object onto a designated area of the virtual object as displayed by the augmented reality display.

14. The augmented reality drag and drop controller of claim 8, wherein the object manager is further configured to control, in cooperation with the physical drag and drop controller of the physical drag and drop device, a drag and drop of the physical object onto a designated region of the physical world.

15. The augmented reality drag and drop controller of claim 8, wherein the object manager is one of:
an object push manager configured to control, in cooperation with the physical drag and drop controller of the physical drag and drop device, a drag and drop of the virtual object relative to the physical object; and
an object pull manager configured to control, in cooperation with the physical drag and drop controller of the physical drag and drop device, a drag and drop of the physical object relative to the virtual object.

16. An augmentation reality drag and drop method, comprising:
displaying via a augmented reality drag and drop device, a virtual object relative to a view of a physical object within a physical world; and
cooperatively controlling, via an augmented reality drag and drop device and a physical drag and drop device, a drag and drop operation involving the virtual object and the physical object.

17. The augmentation reality drag and drop method of claim 16, wherein the cooperative controlling, via the augmented reality drag and drop device and the physical drag and drop device, the drag and drop operation includes at least one of:
a control, via the augmented reality drag and drop device and the physical drag and drop device, of a drag and drop of the virtual object onto the view of the physical object;
a control, via the augmented reality drag and drop device and the physical drag and drop device, of a drag and drop of virtual object onto a designated area of the physical object; and
a control via the augmented reality drag and drop device and the physical drag and drop device, of a drag and drop of the virtual object onto a designate region of the physical world.

18. The augmentation reality drag and drop method of claim 16, wherein the cooperative controlling, via the augmented reality drag and drop device and the physical drag and drop device, the drag and drop operation includes at least one of:
a control, via the augmented reality drag and drop device and the physical drag and drop device, a drag and drop of the physical object onto the virtual object as displayed by the augmented reality display;
a control, via the augmented reality drag and drop device and the physical drag and drop device, a drag and drop of the view of the physical object onto a designated area of the virtual object as displayed by the augmented reality display;
and
a control, via the augmented reality drag and drop device and the physical drag and drop device, a drag and drop of the view of the physical object onto a designated region of the physical world.

19. The augmentation reality drag and drop method of claim 16, wherein the virtual object includes one of a virtual content and a virtual item.

20. The augmentation reality drag and drop method of claim 16, wherein the physical object includes one of a physical content and a physical item.
